(19) United States
(12) Patent Application Publication
(10) Pub. No.: US 2018/0190173 A1
(43) Pub. Date: Jul. 5, 2018

(54) Shift Register and Driving Method Thereof, Gate Driving Circuit and Display Apparatus

(71) Applicants: BOE Technology Group Co., Ltd., Beijing (CN); Hefei BOE Optoelectronics Technology Co., Ltd., Hefei (CN)

(72) Inventor: Silin Feng, Beijing (CN)

(21) Appl. No.: 15/679,841

(22) Filed: Aug. 17, 2017

(30) Foreign Application Priority Data
Jan. 3, 2017 (CN) 201710001506.8

(51) Int. Cl. G09G 3/20

(52) U.S. Cl. CPC G09G 3/20; G09G 2300/0408; G09G 2310/0286

(57) ABSTRACT

Provided are a shift register and driving method thereof, a gate driving circuit and a display apparatus. In the shift resister, an input circuit controls a potential at a first node according to an input signal, an output circuit output an output signal at an output terminal according to the potential of the first node and a first clock signal, a pull-down control circuit controls a potential of a second node according to the potential of the first node and the first clock signal, a pull-down circuit holds the output terminal at a reset status before receiving a next input signal, a reset control circuit enables the pull-down circuit to reset the first node and the output terminal according to a reset signal and the input signal, and a reset circuit resets the first node and the output terminal according to the reset signal and a second clock signal. The shift register has an enhanced ability of resetting and could avoid wasting resources due to idle elements.

This application claims priority to and the benefit of Chinese Patent Application No. 201710001506.8 filed on Jan. 3, 2017, which application is incorporated herein in its entirety.

### TECHNICAL FIELD

Present disclosure relates to a shift register with an enhanced ability of resetting, a driving method thereof, a gate driving circuit comprising the shift register, and a display apparatus.

### BACKGROUND

With developments of display technique, more and more display apparatus adopt a technique of Gate on Array (GOA), that is, form a gate driving circuit in an array on substrate of the display apparatus by using an array process. By adopting GOA technique, costs can be saved, an artistic design of a display panel with symmetrical borders can be achieved, and meanwhile the bonding regions and wiring spaces of fan-out can be omitted for the gate driving circuit so that a design of narrow border can be achieved. In addition, GOA technique does not require bonding in a direction of gate scanning lines, and can improve productive power and yield.

A gate driving circuit usually comprises a plurality of shift registers cascaded together, and gate scanning signals are provided to respective gate lines on the display apparatus in order through each stage of shift register.

A shift register generally has an input terminal, an output terminal, a reset terminal, a first clock signal terminal, a second clock signal terminal, and a reference potential terminal, and comprises an input circuit, an output circuit, a reset circuit, a pull-down circuit, and a pull-down control circuit.

Such a shift register usually operates as follows.

In an inputting phase, an input signal and a second clock signal are received via the input terminal and the second clock signal terminal, respectively, so that a first node and a second node in the shift register become a first potential and a second potential, respectively.

In an outputting phase, the output circuit set the potential of the output terminal to be a first potential, that is, outputs gate driving signal.

In a resetting phase, the reset circuit resets the potentials of the first node and the output terminal, that is, sets the potentials of the first node and the output terminal from the first potential to a second potential.

In a holding phase, that is, after the resetting phase and before receiving a next input signal by the input circuit (i.e. next inputting phase), the potentials of the first node and the output terminal are held at the second potential.

During the above operations, the pull-down circuit only operates during the holding phase and when the potential of the first clock signal terminal is the first potential, but idles during other phases, due to which resources are wasted. Moreover, an ability of resetting of such a shift register is not very good.

### SUMMARY

The present disclosure provides a shift register. The shift register can comprises an input circuit configured to control a potential of a first node in the shift register according to an input signal from an input terminal, an output circuit configured to control an output signal at an output terminal according to the potential of the first node and a first clock signal from a first clock signal terminal, a pull-down control circuit configured to control a potential of a second node in the shift register according to the potential of the first node and the first clock signal, a pull-down circuit configured to hold a potential of the output terminal at a reset status before a next input signal is received at the input terminal, a reset control circuit configured to enable the pull-down circuit to operate to reset potentials of the first node and the output terminal according to a reset signal from a reset terminal and the input signal, and a reset circuit configured to reset the potentials of the first node and the output terminal according to the reset signal and a second clock signal from a second clock signal terminal.

Optionally, the reset control circuit can comprise: a first reset control transistor having a gate connected with the reset terminal, a source connected with a first reference potential terminal, and a drain connected with the second node; and a second reset control transistor having a gate connected with the input terminal, a source connected with the second node, and a drain with a second reference potential terminal.

Optionally, the input circuit can comprise: a first transistor having a gate connected with the input terminal, a source connected with the first reference potential terminal, and a drain connected with the first node.

Optionally, the output circuit can comprise: a second transistor having a gate connected with the first node, a source connected with the first clock signal terminal, and a drain connected with the output terminal; and a capacitor having one end connected with the first node, and the other end connected with the output terminal.

Optionally, the reset circuit can comprise: a third transistor having a gate connected with the reset terminal, a source connected with the first node, and a drain connected with the second reference potential terminal; and a fourth transistor having a gate connected with the second clock signal terminal, a source connected with the output terminal, and a drain connected with a third reference potential terminal.

Optionally, the pull-down circuit can comprise: a fifth transistor having a gate connected with the second node, a source connected with the first node, and a drain connected with the third reference potential terminal; and a sixth transistor having a gate connected with the second node, a source connected with the output terminal, and a drain connected with the third reference potential terminal.

Optionally, the pull-down control circuit can comprise: a seventh transistor having a gate and a source both connected with the first clock signal terminal; an eighth transistor having a gate connected with the first node, a source connected with d drain of the seventh transistor, and a drain connected with the third reference potential terminal; a ninth transistor having a gate connected with the gate of the seventh transistor, a source connected with the first clock signal terminal, and a drain connected with the second node; and a tenth transistor having a gate connected with the first node, a source connected with the second node and a drain connected with the third reference potential terminal.

The present disclosure further provides a gate driving circuit comprising a plurality of shift registers of the present disclosure cascaded together, wherein the reset terminal of each shift register except for a last stage of shift register is connected with the output terminal of a next stage of shift register, and the input terminal of each shift register except for a first stage of shift register is connected with the output terminal of a previous stage of shift register.

Further, the present disclosure also provides a display apparatus comprising the gate driving circuit of the present disclosure.

Further, the present disclosure also provides a driving method of a shift register for driving the shift register of the present disclosure. The method comprises: setting the potential of the first node to be a first potential, and holding potentials of the second node and the output terminal at a second potential, according to the input signal and the second clock signal; holding the potential of the first node at the first potential, holding the potential of the second node at the second potential, and setting the potential of the output terminal to be the first potential, according to the first clock signal; holding the potential of the first node at the first potential, holding the potential of the second node at the second potential, and setting the potential of the output terminal to be the first potential, according to the first clock signal; and holding the potential of the output terminal at the second terminal until receiving the next input signal.

In a case of forward scanning, the reset circuit can operate when receiving the reset signal so as to reset the first node and the output terminal, and the reset control circuit can operate at the same time so as to set the second node to be the first potential, so that the pull-down circuit could operate to reset the potentials of the first node and the output terminal. Further, the reset control circuit can also operate when receiving the input signal so that the second node could be of the second potential and in turn a normal input via the input circuit can be ensured. In a case of backward scanning, the reset control circuit can operate when receiving the input signal so as to setting the second node to be the first potential, so that the pull-down circuit can operate so as to reset the potentials of the first node and the output terminal. The shift register of the present disclosure has a significant enhanced ability of resetting, and can avoid wasting resources due to idle elements in the shift register.

### BRIEF DESCRIPTION OF THE DRAWINGS

FIG. 1 illustrates a traditional GOA circuit.

FIG. 2 illustrates a block diagram of a traditional shift register.

FIG. 3 illustrates a circuit of a traditional shift register.

FIG. 4 illustrates a timing sequence of a traditional shift register.

FIG. 5 illustrates a block diagram of a shift register according to an embodiment of the present disclosure.

FIG. 6 illustrates a circuit of a shift register according to an embodiment of the present disclosure.

FIG. 7 illustrates a timing sequence of a shift register according to an embodiment of the present disclosure.

FIG. 8 illustrates a method for driving a shift register according to an embodiment of the present disclosure.

FIG. 9 illustrates a GOA circuit comprising a plurality of shift registers according to an embodiment of the present disclosure, where are cascaded together.

### DETAILED DESCRIPTION

The shift register and driving method thereof, the gate driving circuit and display apparatus of the present disclosure are described below by making reference to the drawings and in connection with embodiments. For continence, in the following, receiving a signal means that the potential of the received signal is a first potential, or the potential of corresponding terminal of the shift register for receiving this signal is the first potential. Not receiving a signal means that the potential of the signal is a second potential, or the potential of corresponding terminal of the shift register for receiving this signal is the second potential. For example, receiving an input signal and a first clock signal means that an input terminal for receiving the input signal and a first clock signal terminal for receiving a first clock signal of the shift register are both first potential.

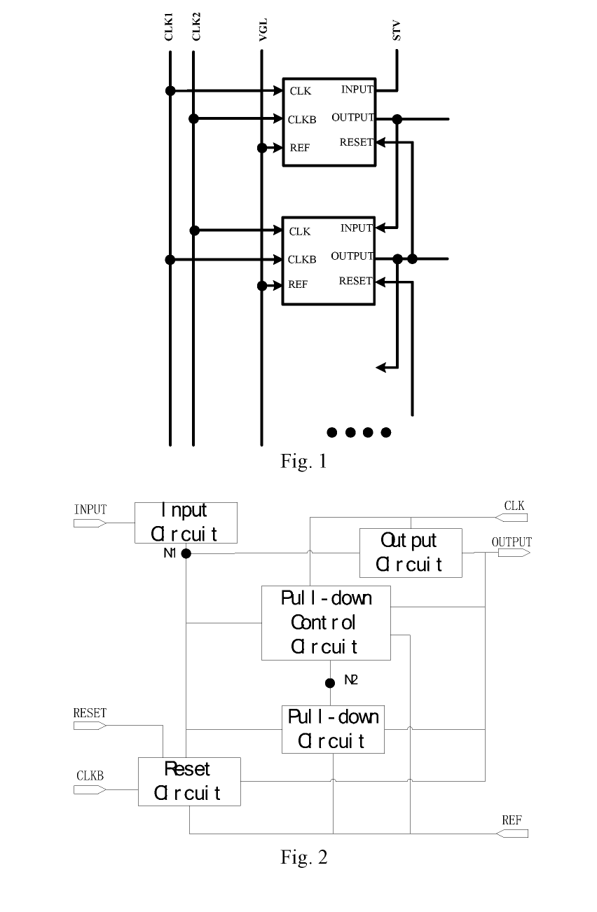

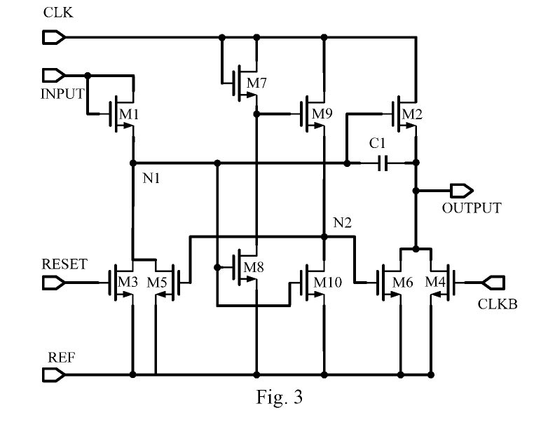

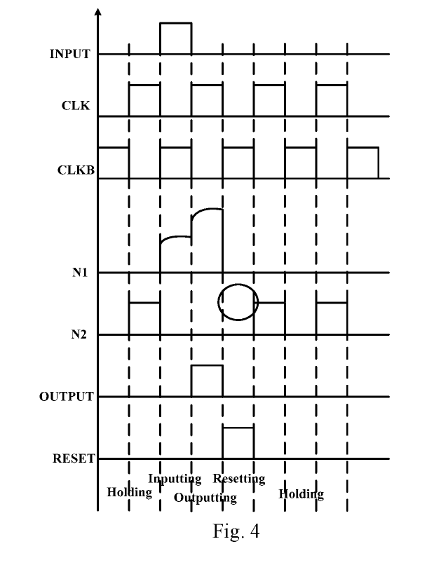

FIG. 1 illustrates a GOA circuit comprising a plurality of traditional shift registers cascaded together. As shown in FIG. 1, a traditional shift register has an input terminal INPUT, an output terminal OUTPUT, a reset terminal RESET, a first clock signal terminal CLK connected to one of the clock signal lines CLK1 and CLK2, a second clock signal terminal CLKB connected to the other of the clock signal lines CLK1 and CLK2, and a reference potential terminal REF connected to a reference potential line (for example, the reference potential line VGL). As shown in FIGS. 2 and 3, in an example of the traditional shift register, the input circuit can comprise a transistor M1, the output circuit can comprises a transistor M2 and a capacitor C1, the reset circuit can comprises transistors M3 and M4, the pull-down circuit can comprises transistors M5 and M6, and the pull-down circuit can comprises transistors M7, M8, M9, and M10. As shown in FIG. 4, during the inputting phase, the outputting phase, and the resetting phase, and when the potential of the second clock signal terminal CLKB is the second potential during the holding phase, the potential of the second node N2 in the traditional shift register is the second potential, resulting in that transistors M5 and M6 in the pull-down circuit in FIG. 3 are turned off during all of the aforesaid phases. That is, the pull-down circuit does not operate, resulting in a wasting of resources and a poor ability of resetting for such a shift register.

An shift register according to an embodiment of the present disclosure comprises a reset control circuit so that the potential of the second node N2 can be the first potential at least during the resetting phase, and in turn the pull-down circuit can operate at least during the resetting phase and achieve, together with the reset circuit, a reset for the output terminal of the shift register, so as to improve both an ability of reset and utilization of resources.

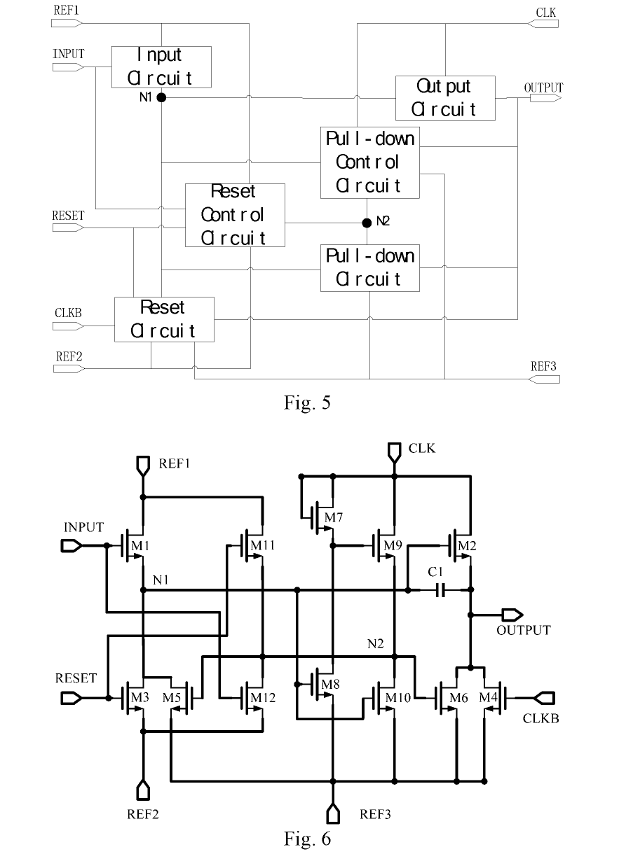

As shown in FIG. 5, an shift register according to an embodiment of the present disclosure can comprise an input terminal INPUT, an output terminal OUTPUT, a reset terminal RESET, a first clock signal terminal CLK, a second clock signal terminal CLKB, a first reference potential terminal REF1, a second reference potential terminal REF2, and a third reference potential terminal REF3, and can further comprises an input circuit, an output circuit, a reset circuit, a pull-down circuit, a pull-down control circuit, and a reset control circuit.

The input circuit is connected with the input terminal INPUT, the first reference potential terminal REF1, and a first node N1 in the shift register, and can control the potential of the first node N1 according to an input signal received via the input terminal INPUT. For example, the input circuit can set the potential of the first node N1 same with the potential of the first reference potential terminal REF1 in a case of receiving the input signal via the input terminal INPUT. In one embodiments, the input circuit can comprises a switch element (for example, a transistor switch element), and can be referred as an input switch or an input sub-circuit, wherein the switch element can switch on when the input signal is received at its control terminal, so that the first node N1 and the first reference potential terminal REF1 are switched into conduction, and the potential of the first node N1 becomes the same with the potential of the first reference potential terminal REF1.

The output circuit is connected with the output terminal OUTPUT, the first node N1, and the first clock signal terminal CLK, and can controls the potential of the output terminal OUTPUT according to the potential of the first node N1 and a first clock signal received via the first clock signal terminal CLK. In one embodiment, the output circuit can output a signal, whose potential is the first potential, to the output terminal OUTPUT as the output signal in a case where the potential of the first node N1 is not the second potential and the potential of the first clock signal terminal CLK is the first potential, and can hold the potential of the first node N1 so that it will not become the second potential. In one embodiment, the output circuit can comprises a switch element (for example, a transistor switch) and a storage element (for example, a capacitor), and can be referred as an output switch or an output sub-circuit, wherein the switch element has its control terminal connected to the first node N1, and switches on in a case where the potential of the first node N1 is the first potential, so as to switch the output terminal OUTPUT and the first clock signal terminal CLK into conduction and set the potential of the output terminal OUTPUT the same with the potential of the first clock signal received via the first clock signal terminal CLK, thereby outputting a gate driving signal with a potential of the first potential. Further, the storage element has one end connected with the first node N1, so as to ensure, by the stored charges, that the potential of the first node N1 will not change to the second potential during the outputting phase.

The reset circuit is connected with the reset terminal RESET, the first node N1, the second clock signal terminal CLKB, the output terminal OUTPUT, the second reference potential terminal REF2, and the third reference potential terminal REF3, and resets the potentials of the first node N1 and the output terminal OUTPUT according to a reset signal received via the reset terminal RESET and a second clock signal received via the second clock signal terminal CLKB. In one embodiments, the reset circuit can comprises a switch element (for example, a transistor switch), and can be referred as a reset switch or a reset sub-circuit, wherein the switch element has its control terminal connected to the reset terminal RESET, and switches on in a case where the potential of the reset terminal RESET is the first potential, so as to switch the first node N1 and/or the output terminal OUTPUT into conduction with the second reference potential terminal REF2 and/or the third reference potential terminal REF3, and set the potentials of the first node N1 and/or the output terminal OUTPUT to be the same with the potentials of the second reference potential terminal REF2 and/or the third reference potential terminal REF3. For example, the reset switch can comprises two set of switch elements, wherein a first set has their control terminals connected to the reset terminal RESET and switch on in a case where the potential of the reset terminal RESET is the first potential, so as to switch the first node N1 with the second reference potential terminal REF2 into conduction, and set the potential of the first node N1 to be the same with the potential of the second reference potential terminal REF2, and wherein a second set has their control terminals connected to the second clock signal terminal CLKB and switch on in a case where the potential of the second clock signal terminal CLKB is the first potential, so as to switch the output terminal OUTPUT and the third reference potential terminal REF3 into conduction, and set the potential of the output terminal OUTPUT the same with the potential of the third reference potential terminal REF3.

The pull-down module is connected with the first node N1, the output terminal OUTPUT, the third reference potential terminal REF3, and a second node N2 in the shift register, and can hold the output terminal OUTPUT at the second potential after the potential of the output terminal OUTPUT is reset and before a next input signal is received by the input circuit via the input terminal INPUT. In one embodiment, the pull-down circuit can operate in a case where the potential of the second node N2 is the first potential, so as to set the potential of the first node N1 to be the same with the potential of the second reference potential terminal REF2, and set the potential of the output terminal OUTPUT to be the same with the potential of the second reference potential terminal REF2. In one embodiment, the pull-down circuit can comprises a switch element (for example, a transistor switch element), and can be referred as a pull-down switch or a pull-down sub-circuit, wherein the pull-down switch has a control terminal connected with the second node N2, a first terminal connected to the first node N1 and the output terminal OUTPUT, and a second terminal connected to the third reference potential terminal REF3, and switch the first node N1 and the third reference potential terminal REF3 into conduction, and the output terminal OUTPUT and the third reference potential terminal REF3 into conduction, so that the potentials of the first node N1 and the output terminal OUTPUT become the same with the third reference potential terminal REF3.

The pull-down control circuit is connected with the first node N1, the first clock signal terminal CLK, the output terminal OUTPUT, the second node N2, and the third reference potential terminal REF3, and can control the potential of the second node N2 according to the potential of the first node N1 and the first clock signal. In one embodiment, the pull-down control module can comprise a switch element (for example, a transistor switch), and can be referred as a pull-down control switch or a pull-down control sub-circuit, wherein the pull-down control switch has one control terminal connected with the first node N1, and switches the second node N2 and the third reference potential terminal REF3 into conduction, so as to set the potential of the second node N2 to be the same with the potential of the third reference potential terminal REF3, in a case where the potential of the first node N1 is not the second potential. In one embodiment, the potential of the third reference potential terminal REF3 can be set to be the second potential so that, in a case where the potential of the first node N1 is not the second potential, the pull-down control switch can control the potential of the second node N2 to be the second potential to ensure that the pull-down circuit does not operate. Thus, the first node N1 can be avoided from becoming the second potential, and in turn a normal operation can be ensured for the output circuit or output switch.

The reset control module is connected with the input terminal INPUT, the reset terminal RESET, the first reference potential terminal REF1, the second reference potential terminal REF2, and the second node N2, and can control the potential of the second node N2 so that the pull-down circuit can also cooperate with the reset circuit during the resetting phase to reset the potential of the output terminal OUTPUT. In one embodiment, the reset control circuit can operate in a case where a reset signal is received via the reset terminal RESET, so that the potential of the second node N2 can be the same with the potential of the first reference potential terminal REF1. In another embodiment, the reset control circuit can operate in a case where an input signal is received via the input terminal INPUT, so that the potential of the second node N2 can be the same with the second reference potential terminal REF2. In one embodiment, the reset control circuit can comprises a switch element (for example, a transistor switch), and can be referred as a reset control switch, wherein the reset control switch can have a first control terminal connected to the reset terminal RESET, and a second control terminal connected to the output terminal OUTPUT, and can switch on in a case where the potential of the potential of the reset terminal RESET or the input terminal INPUT is the first potential. In a case where the potential of the reset terminal RESET is the first terminal, the reset control switch is on, and switches the first reference potential terminal REF1 and the second node N2 into conduction, so that the potential of the second node N2 becomes the same with the potential of the first reference potential terminal REF1. In a case where the potential of the input terminal INPUT is the first potential, the reset control switch is on, and switches the second reference potential terminal REF2 and the second node N2 into conduction, so that the potential of the second node N2 becomes the same with the potential of the second reference potential terminal REF2. In one embodiment, the potential of the first reference potential REF1 can be set to be the first potential. Then, as described above, in a case where the potential of the reset terminal RESET is the first potential, the reset switch is on so as to reset the potentials of the first node N1 and the output terminal OUTPUT. Since the reset control switch is also on, through which the potential of the second node N2 becomes the same with the potential of the first reference potential terminal REF1, that is, the potential of the second node N2 becomes the first potential, then the pull-down switch is also on at the same time, and resets the potentials of the first node N1 and the output terminal OUTPUT together with the reset switch. The ability of resetting can thus be enhanced.

In one embodiment, the potentials of the clock signals received respectively via the first clock signal terminal CLK and the second clock signal terminal CLKB are always not the same with each other at the same time. For example, when the potential of the first clock signal received via the first clock signal terminal CLK is the first potential, the potential of the second clock signal received via the second clock signal terminal CLKB is the second potential, and when the potential of the first clock signal is the second potential, the potential of the second clock signal can be the first potential.

The shift register according to embodiments of the present disclosure can support scanning in two directions. For example, in a case of forward scanning, the potential of the first reference potential terminal REF1 can be set to be the first potential, and the potential of the second reference potential terminal REF2 can be set to be the second potential, and in a case of backward scanning, the potential of the first reference potential terminal REF1 can be set to be the second potential, and the potential of the second reference potential terminal REF2 can be set to be the first potential. In one embodiment, in a case of forward scanning, the reset control circuit can operate under a control of the received reset signal to enable the pull-down circuit to operate and reset the first node N1 and the output terminal OUTPUT. In a case of backward scanning, the reset control circuit can operate under a control of the received input signal to set the potentials of the second node N2 and the second reference potential terminal REF2 to be the same, that is, to be the first potential, so that the pull-down circuit operates and resets the first node N1 and the output terminal OUTPUT.

In one embodiment, as shown in FIG. 6, in the shift register according to the embodiment of the present disclosure, the input circuit or input switch can comprises: a transistor M1 having a gate connected with the input terminal INPUT, a source connected with the first reference terminal REF1, and a drain connected with the first node N1. The transistor M1 can turn on in case where an input signal is received via the input terminal INPUT, so as to control the potential of the first node N1 to be the same with the potential of the first reference potential terminal REF1. It will be appreciated that the implementations for the input circuit of the shift register according to embodiments of the present disclosure are not limited thereto.

In one embodiment, as shown in FIG. 6, in the shift register according to the embodiment of the present disclosure, the output circuit or the output switch can comprise a transistor M2 and a capacitor C1, wherein a gate of the transistor M2 and one end of the capacitor C1 are connected to the first node N1, a source of the transistor M2 is connected to the first clock signal terminal CLK, and a drain of the transistor M2 and the other end of the capacitor C1 are connected to the output terminal C1. The transistor M2 can turn on in a case where the potential of the first node N1 is not the second potential, and can output an output signal, whose potential is the first potential, to the output terminal OUTPUT in a case where a first clock signal is received via the first clock signal terminal CLK. The capacitor C1 can hold the potential of the first node so that it cannot become the second potential during the output signal whose potential is the first potential is being outputted to the output terminal OUTPUT, so as to ensure a correct output of the shift register. It will be appreciated that the implementations for the output circuit of the shift register according to embodiments of the present disclosure are not limited thereto.

In one embodiment, as shown in FIG. 6, in the shift register according to the embodiment of the present disclosure, the reset circuit or the reset switch can comprises transistors M3 and M4, wherein the transistor M3 has a gate, a source, and a drain connected with the reset terminal RESET, the first node N1, and the second reference potential reference terminal REF2, respectively, and the transistor M4 has a gate, a source, and a drain connected with the second clock signal terminal CLKB, the output terminal OUTPUT, and the third reference potential terminal REF3, respectively. The transistor M3 can turn on in a case where a reset signal is received via the reset terminal RESET so that the potential of the first node N1 can become the same with the potential of the second reference potential terminal REF2. At the same time, the transistor M4 can turn on in a case where a second clock signal is received via the second clock signal terminal CLKB so that the potential of the output terminal OUTPUT can become the same with the potential of the third reference potential terminal REF3. In one embodiment, the third reference potential terminal REF3 can be connected to a reference potential line of the second potential VGL, so that the potential of the output terminal OUTPUT can be reset to be the second terminal in a case where the transistor M4 is turned on. It will be appreciated that the implementations for the reset circuit of the shift register according to embodiments of the present disclosure are not limited thereto.

In one embodiment, as shown in FIG. 6, in the shift register according to the embodiment of the present disclosure, the pull-down circuit or the pull-down switch can comprises transistors M5 and M6, wherein the transistor M5 has a gate, a source, and a drain connected to the second node N2, the first node N1, and the second reference potential terminal REF2, respectively, and the transistor M6 has a gate, a source, and a drain connected to the second node N2, the output terminal OUTPUT, and the third reference potential terminal REF3, respectively. In one embodiment, the transistors M5 and M6 can both turn on in a case where the potential of the second node N2 is the first potential so that the potential of the first node N1 can become the same with the potential of the second reference potential terminal REF2, and the potential of the output terminal OUTPUT can become the same with the third reference potential terminal REF3. It will be appreciated that the implementations for the pull-down circuit of the shift register according to embodiments of the present disclosure are not limited thereto.

In one embodiment, as shown in FIG. 6, in the shift register according to the embodiment of the present disclosure, the pull-down control circuit can comprise transistors M7, M8, M9, and M10, wherein a gate and a source of the transistor M7, and a source of the transistor M9 are connected with the first clock signal terminal CLK; gates of the transistors M8 and M10 are connected with the first node N1; a drain of the transistor M9 and a source of the transistor M10 are connected with the second node N2; a drain of the transistor M7, a gate of the transistor M9 are connected with a source of the transistor M8; and drains of the transistors M8 and M10 are connected with the third reference potential terminal REF3. In one embodiment, each of the transistors M7, M8, M9, and M10 can turn on in a case where a signal of a first potential is received at the gate. It will be appreciated that the implementations for the pull-down control circuit of the shift register according to embodiments of the present disclosure are not limited thereto.

In one embodiment, as shown in FIG. 6, in the shift register according to the embodiment of the present disclosure, the reset control circuit can comprise transistors M11 and M12 (also referred as reset control transistors M11 and M12), wherein the transistor M11 has a gate, a source, and a drain connected to the reset terminal RESET, the first reference potential terminal REF1, and the second node N2, respectively, and the transistor M12 has a gate, a source, and a drain connected to the input terminal INPUT, the second node N2, and the second reference potential terminal REF2, respectively. In one embodiment, the transistor M11 can turn on in a case where a reset signal is received via the reset terminal RESET, so that the potential of the second node N2 can be the same with the potential of the first reference potential terminal REF1 so as to enable the pull-down circuit to operate to reset the potentials of the first node N1 and the output terminal OUTPUT. In one embodiment, the transistor M12 can turn on in a case where an input signal is received via the input terminal INPUT, so that the potential of the second node N2 can be the same with the potential of the second reference potential terminal REF2. It will be appreciated that the implementations for the reset control circuit of the shift register according to embodiments of the present disclosure are not limited thereto.

It will be appreciated that the transistors in each of the above embodiments can be either a thin film transistor, or a Metal-Oxide-Semiconductor Field-Effect Transistor, and the present disclosure is not limited thereto. Optionally, all the transistors adopted in each of the above embodiments can be transistors made of same materials, and can adopt either P-channel type transistors or N-channel type transistors for simplicity of the process. For example, in a case where a high level is adopted as the first potential and a transistor turns on when a signal of high level is received at the gate, each of the transistors M1-M12 in each of the above embodiments can be a N-channel type transistor; whereas in a case where a low level is adopted as the first potential and a transistor turns on when a signal of low level is received at the gate, each of the transistors M1-M12 in each of the above embodiments can be a P-channel type transistor. Turning on of a transistor switches the elements and/or sub-circuits and/or modules connected respectively with the functions of source and drain of the transistor into conduction. Further, the source and drain of a transistor can be exchanged depending on the types of the adopted transistor and the received signal, and the present disclosure is not limited thereto. Further, other switch elements or switch sub-circuits can also be adopted in each of the above embodiments, and the present disclosure is not limited thereto.

An operating process of the shift register according to one embodiment of the present disclosure will be described below so as to set forth the operating principles of the shift register of the present disclosure.

In the embodiment, the shift register adopts a circuit as shown in FIG. 6, wherein all the switch elements are N-channel type transistors, and turn on in a case of the first potential and turn off in a case of the second potential, wherein the potential of the first reference potential terminal REF1 is the first potential, and the potentials of the second reference potential terminal REF2 and the third reference potential terminal REF3 are both the second potential, and wherein the potentials of the first clock signal terminal CLK and the second clock signal terminal CLKB are always opposite to each other, and the potentials of the first clock signal terminal and the second clock signal terminal are the second potential and the first potential, respectively, when an input signal is received via the input terminal INPUT. For convenience of description, the first potential and the second potential are expressed as 1 and 0, respectively. For example, INPUT=1 indicates that the potential of the input terminal INPUT is the first potential, RESET=0 indicates that the potential of the reset terminal RESET is the second potential, and N2=REF3=0 indicates that the potential of the second node N2 become the same with the potential of the third reference potential terminal REF3 and becomes the second potential, and so on.

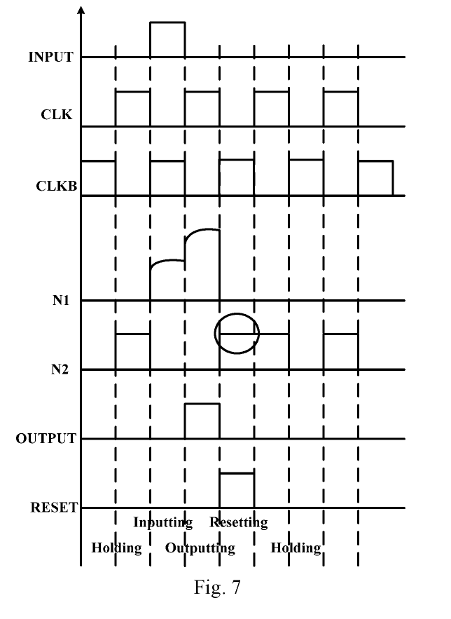

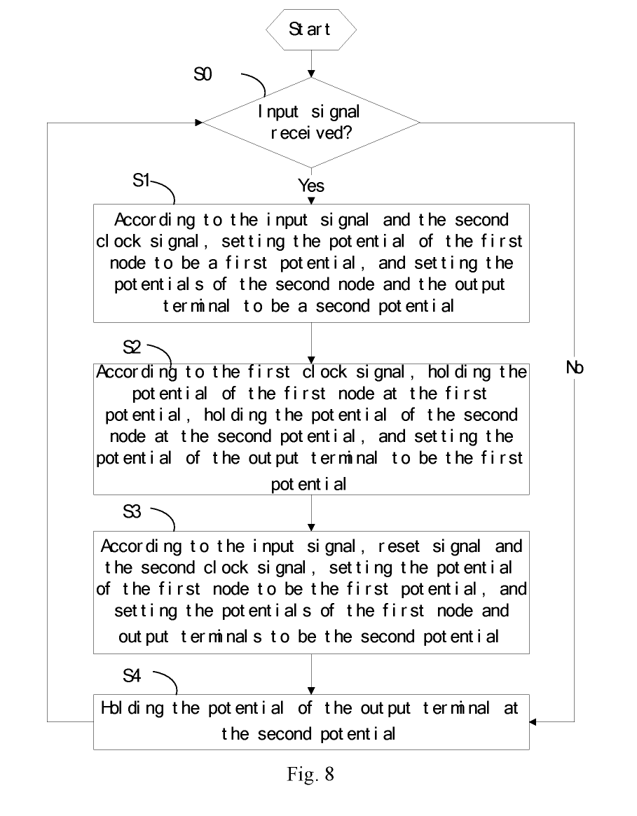

As shown in FIG. 7, an operating process of the shift register according to one embodiment of the present disclosure can comprises an inputting phase, an outputting phase, a resetting phase, and a holding phase.

In the inputting phase, INPUT=1, RESET=0, CLK=0, and CLKB=1. During this phase, the transistor M1 in the input circuit turns on, and switches the first node N1 and the first reference potential terminal REF1 into conduction, so that N1=REF1=1. At the same time, the capacitor C1 in the output circuit begins to charge, and the transistor M2 in the output circuit turns on to switch the output terminal OUTPUT and the first clock signal terminal CLK into conduction, so that OUTPUT=CLK=0. The transistor M4 in the reset circuit turns on due to a reception of the second clock signal and switches the output terminal OUTPUT and the third reference potential terminal REF3 into conduction, so that OUTPUT=REF3=0. In addition, the transistor M3 in the reset circuit turns off due to RESET=0. At the same time, transistors M7 and M9 turn off, and transistors M8 and M10 turn on and switch the second node N2 and the third reference potential terminal REF3 into conduction, so that N2=REF3=0, and thus the transistors M5 and M6 in the pull-down circuit also turn off so that a normal input of the shift register can be ensured.

In the outputting phase after the inputting phase, INPUT=0, RESET=0, CLK=1, and CLKB=0. During this phase, the capacitor C1 in the output circuit keeps the potential of the first node N1 from being the second potential, and thus the transistor M2 in the output circuit turns on because the potential of the first node N1 is the first potential, so that the output terminal OUTPUT and the first clock signal terminal CLK are switched into conduction, and OUTPUT=CLK=1, that is, an output signal whose potential is the first potential is output at the output terminal OUTPUT. At the same time, transistors M8 and M10 in the pull-down control circuit turn off due to a turn-on of transistor M9, and switch the second node N2 and the third reference potential terminal REF3 into conduction, so that N2=REF3=0. Transistors M5 and M6 in the pull-down circuit turn off due to N2=0, so as to ensure a normal output of the shift register. In order to make sure that the transistor M9 can turn off during this phase, in one embodiment, the ratio between the sizes of transistors M8 and M7 for controlling the potential at the gate of transistor M9 can be set to be larger than or equal to 5:1. A transistor will have a smaller on-resistance when having a larger size, and correspondingly, will have a smaller divided voltage. Thus, by setting the ratio between the sizes of transistors M8 and M7 to be larger than or equal to 5:1, the transistor M9 can be ensured to have a low level at the gate and thus turn off when the transistors M8 and M7 are both turning on.

During the resetting phase after the outputting phase, INPUT=0, RESET=1, CLK=0, and CLKB=1. During this phase, the transistor M3 in the reset circuit turns on and switches the first node N1 and the second reference potential terminal REF2 into conduction, so that N1=REF2=0. The transistor M2 in the output circuit turns off due to N1=0. At the same time, the transistor M4 in the reset circuit turns on due to CLKB=1, and switches the output terminal OUTPUT and the third reference potential terminal REF3 into conduction, so that OUTPUT=REF3=0. Thus, the reset circuit resets the potentials of the first node N1 and the output terminal OUTPUT. At the same time, the transistor M11 in the reset control circuit turns on due to RESET=1, and switches the second node N2 and the first reference potential terminal REF1 into conduction, so that N2=REF1=1. Then, the transistors M5 and M6 in the pull-down circuit turn on, and switch the first node N1 and the second reference potential terminal REF2, as well as the output terminal OUTPUT and the third reference potential terminal REF3, into conduction, so that N1=REF2=0 and OUTPUT=REF3=0. Thus, the pull-down circuit resets the potential of the first node N1 and the output terminal OUTPUT.

During the holding phase after the resetting phase, INPUT=0 and RESET=0.

During the holding phase, when CLK=1 and CLKB=0, transistors M7 and M9 in the pull-down control circuit turn on and switch the second node N2 and the first clock signal terminal CLK into conduction, so that N2=CLK=1, and thus transistors M5 and M6 in the pull-down circuit turn on so that N1=REF2=0 and OUTPUT=REF3=0. When CLK=0 and CLKB=1, the transistor M2 in the output circuit turns off, and all the transistors in the pull-down control circuit turn off, and thus N2=0. At the same time, the transistor M4 in the reset circuit turns on due to CLKB=1, and switches the output terminal OUTPUT and the third reference potential terminal REF3 into conduction, so that OUTPUT=REF3=0.

Then, the shift register repeats the operating process during the holding phase until a next input signal is received via the input terminal INPUT.

In the shift register according to an embodiment of the present disclosure, the reset control circuit can operate at least during the resetting phase so that N2=1. And thus, the pull-down circuit can operate and can reset the potentials of the first node N1 and the output terminal OUTPUT together with the reset circuit. In this way, the utilization of the elements in the shift register, e.g. the pull-down circuit, can be improved, and the ability of resetting can be enhanced because the pull-down circuit can operate with the reset circuit at least during the resetting phase so as to realize the resetting function.

Further, the shift register according to an embodiment of the present disclosure can support scanning in two directions. In one embodiment, in a case of a forward scanning, the potential of the first reference potential terminal REF1 can be the first potential, and the potential of the second reference potential terminal REF2 can be the second potential. The operating process in a case of a forward scanning can be similar with that is shown in FIG. 7. In a case of a backward scanning, the potential of the first reference potential terminal REF1 can be the second potential, and the potential of the second reference potential terminal REF2 can be the first potential. In such a case, when an input signal is receive via the input terminal INPUT, the transistor M12 in the reset control circuit turns on, so that N2=1, and thus transistors M5 and M6 in the pull-down circuit turn on so that N1=OUTPUT=0. In a case of the backward scanning, the arrangement of the reset control circuit can also improve the utilization of the elements in the shift register, e.g. the pull-down circuit, and can significantly improve the ability of resetting.

The structure, circuit implementation and operating principle of the shift register according to embodiments of the present disclosure have been described above taking N-channel type transistors as examples. In another example, P-channel type transistors can be adopted to implement the shift register of the present disclosure, and the operating process is similar with that with respect to the above examples of N-channel type transistors, with a difference that P-channel type transistors turn on in a case of the second potential. Related details are omitted herein.

FIG. 8 illustrates a method for driving a shift register according to an embodiment of the present disclosure, wherein steps of S1 to S4 can correspond to the inputting phase, the outputting phase, the resetting phase, and the holding phase of the shift register, respectively.

As shown in FIG. 8, at step S0, it is detected whether an input signal is received. If an input signal is received, the method proceeds to step S1, otherwise to step S4. At step S1, INPUT=1, RESET=0, CLK=0, and CLKB=1, so that N1=1 and N2=0. At step S2, INPUT=0, RESET=0, CLK=1, and CLKB=0, so that the potential of the first node N1 is held at the first potential, the potential of the second node N2 is held at the second potential, and OUTPUT=1. At step S3, INPUT=0, RESET=1, CLK=0, CLKB=1, so that N2=1, N1=0, and OUTPUT=0. At step S4, INPUT=0, RESET=0, and the potential of the output terminal OUTPUT is held at the second potential. Then, the method returns to step S0.

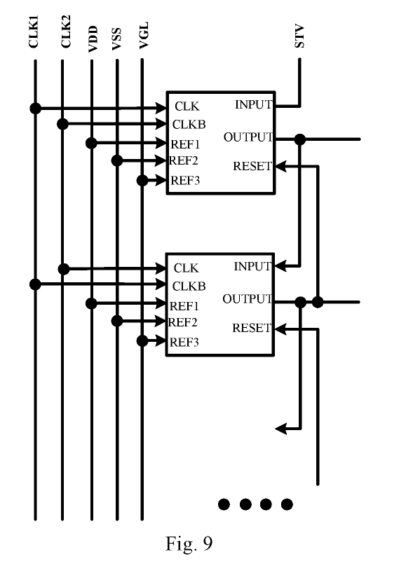

FIG. 9 illustrates a gate driving circuit comprising a plurality of shift registers according to an embodiment of the present disclosure, where are cascaded together.

As shown in FIG. 9, in one embodiment, for each stage of register, the first reference potential terminal REF1 can be connected with the reference potential line VDD, the second reference potential terminal REF2 can be connected with the reference potential line VSS, the third reference potential terminal REF3 can be connected with the reference potential line VGL, the first clock signal terminal CLK can be connected with one of the clock signal lines CLK1 and CLK2, and the second clock signal terminal CLKB can be connected with the other of the clock signal lines CLK1 and CLK2. For each stage of register except for the last stage of shift register, the reset terminal RESET can be connected to the output terminal OUTPUT of a next stage of shift register. That is, each stage of register except for the last stage of shift register receives the output signal from a next stage of shift register as a reset signal. For each stage of register except for the first stage of shift register, the input terminal INPUT can be connected to the output terminal OUTPUT of a previous stage of shift register. That is, each stage of register except for the first stage of shift register receives the output signal from a previous stage of shift register as an input signal.

The gate driving circuit according to the embodiments of the present disclosure can support scanning in two directions. In one embodiment, in a case of forward scanning, a voltage with the first potential can be supplied to the reference potential line VDD, a voltage with the second potential can be supplied to the reference potential line VSS, the input terminal INPUT of the first stage of shift register can receive a frame start signal STV of the current frame, and the reset terminal RESET of the last stage of shift register can receive a frame start signal STV of the next frame. In a case of backward scanning, a voltage with the second potential can be supplied to the reference potential line VDD, a voltage with the first potential can be supplied to the reference potential line VSS, the input terminal INPUT of the first stage of shift register can receive the frame start signal STV of the next frame, and the reset terminal RESET of the last stage of shift register can receive the frame start signal STV of the current frame.

Further, the above gate driving circuit can be adopted in a display apparatus, wherein the gate driving circuit comprises a plurality of shift registers according to the embodiments of the present disclosure, which are cascaded together, so as to provide a high utilization of resources and an enhanced ability of resetting.

Some embodiments of the shift register and driving method thereof, the gate driving circuit and display apparatus of the present disclosure have been described above. It will be appreciated that the above described embodiments are only a part of embodiments of the present disclosure, rather than all embodiments. Various modifications and variations can be made to the described embodiments according to the principles described herein, which are also involved in the present disclosure.

The present application claims the priority of a Chinese Patent Application No. 201710001506.8 filed on Jan. 3, 2017, the contents of which are incorporated herein fully by reference as a part of the present disclosure.

What is claimed is:

1. A shift register, comprising:
an input circuit configured to control a potential of a first node in the shift register, according to an input signal from an input terminal,
an output circuit configured to control an output signal at an output terminal, according to the potential of the first node and a first clock signal from a first clock signal terminal,
a pull-down control circuit configured to control a potential of a second node in the shift register, according to the potential of the first node and the first clock signal,
a pull-down circuit configured to hold a potential of the output terminal at a reset status before a next input signal is received at the input terminal,
a reset control circuit configured to enable the pull-down circuit to operate to reset potentials of the first node and the output terminal, according to a reset signal from a reset terminal and the input signal, and
a reset circuit configured to reset the potentials of the first node and the output terminal, according to the reset signal and a second clock signal from a second clock signal terminal.

2. The shift register of claim 1, wherein the reset control circuit comprises:
a first reset control transistor having a gate connected with the reset terminal, a source connected with a first reference potential terminal, and a drain connected with the second node, and
a second reset control transistor having a gate connected with the input terminal, a source connected with the second node, and a drain with a second reference potential terminal.

3. The shift register of claim 1, wherein the input circuit comprises:
a first transistor having a gate connected with the input terminal, a source connected with a first reference potential terminal, and a drain connected with the first node.

4. The shift register of claim 1, wherein the output circuit comprises:
a second transistor having a gate connected with the first node, a source connected with the first clock signal terminal, and a drain connected with the output terminal, and
a capacitor having one end connected with the first node, and the other end connected with the output terminal.

5. The shift register of claim 1, wherein the reset circuit comprises:
a third transistor having a gate connected with the reset terminal, a source connected with the first node, and a drain connected with a second reference potential terminal, and
a fourth transistor having a gate connected with the second clock signal terminal, a source connected with the output terminal, and a drain connected with a third reference potential terminal.

6. The shift register of claim 1, wherein the pull-down circuit comprises:
a fifth transistor having a gate connected with the second node, a source connected with the first node, and a drain connected with a third reference potential terminal, and
a sixth transistor having a gate connected with the second node, a source connected with the output terminal, and a drain connected with the third reference potential terminal.

7. The shift register of claim 1, wherein the pull-down control circuit comprises:
a seventh transistor having a gate and a source both connected with the first clock signal terminal,
an eighth transistor having a gate connected with the first node, a source connected with a drain of the seventh transistor, and a drain connected with a third reference potential terminal,
a ninth transistor having a gate connected with the gate of the seventh transistor, a source connected with the first clock signal terminal, and a drain connected with the second node, and
a tenth transistor having a gate connected with the first node, a source connected with the second node, and a drain connected with the third reference potential terminal.

8. A gate driving circuit, comprising a plurality of shift registers of claim 1 cascaded together, wherein,
the reset terminal of each shift register except for a last stage of shift register is connected with the output terminal of a next stage of shift register, and
the input terminal of each shift register except for a first stage of shift register is connected with the output terminal of a previous stage of shift register.

9. A display apparatus, comprising the gate driving circuit of claim 8.

10. A driving method of a shift register for driving the shift register of claim 1, comprising:
setting the potential of the first node to be a first potential and holding potentials of the second node and the output terminal at a second potential, according to the input signal and the second clock signal,
holding the potential of the first node at the first potential, holding the potential of the second node at the second potential, and setting the potential of the output terminal to be the first potential, according to the first clock signal,
setting the potential of the second node to be the first potential and setting the potentials of the first node and the output terminal to be the second potential, according to the input signal, the reset signal, and the second clock signal, and
holding the potential of the output terminal at the second terminal until receiving the next input signal.

11. The gate driving circuit of claim 8, wherein, for each shift register, the reset control circuit comprises:
a first reset control transistor having a gate connected with the reset terminal, a source connected with a first reference potential terminal, and a drain connected with the second node, and
a second reset control transistor having a gate connected with the input terminal, a source connected with the second node, and a drain with a second reference potential terminal.

12. The gate driving circuit of claim 8, wherein, for each shift register, the input circuit comprises:
a first transistor having a gate connected with the input terminal, a source connected with a first reference potential terminal, and a drain connected with the first node.

13. The gate driving circuit of claim 8, wherein, for each shift register, the output circuit comprises:
a second transistor having a gate connected with the first node, a source connected with the first clock signal terminal, and a drain connected with the output terminal, and
a capacitor having one end connected with the first node, and the other end connected with the output terminal.

14. The gate driving circuit of claim 8, wherein, for each shift register, the reset circuit comprises:
a third transistor having a gate connected with the reset terminal, a source connected with the first node, and a drain connected with a second reference potential terminal, and
a fourth transistor having a gate connected with the second clock signal terminal, a source connected with the output terminal, and a drain connected with a third reference potential terminal.

15. The gate driving circuit of claim 8, wherein, for each shift register, the pull-down circuit comprises:
a fifth transistor having a gate connected with the second node, a source connected with the first node, and a drain connected with a third reference potential terminal, and
a sixth transistor having a gate connected with the second node, a source connected with the output terminal, and a drain connected with the third reference potential terminal.

16. The gate driving circuit of claim 8, wherein, for each shift register, the pull-down control circuit comprises:
a seventh transistor having a gate and a source both connected with the first clock signal terminal,
an eighth transistor having a gate connected with the first node, a source connected with a drain of the seventh transistor, and a drain connected with a third reference potential terminal,
a ninth transistor having a gate connected with the gate of the seventh transistor, a source connected with the first clock signal terminal, and a drain connected with the second node, and
a tenth transistor having a gate connected with the first node, a source connected with the second node, and a drain connected with the third reference potential terminal.

17. The display apparatus of claim 9, wherein, for each shift register in the gate driving circuit, the reset control circuit comprises:
a first reset control transistor having a gate connected with the reset terminal, a source connected with a first reference potential terminal, and a drain connected with the second node, and
a second reset control transistor having a gate connected with the input terminal, a source connected with the second node, and a drain with a second reference potential terminal.

18. The display apparatus of claim 9, wherein, for each shift register in the gate driving circuit, the input circuit comprises:
a first transistor having a gate connected with the input terminal, a source connected with a first reference potential terminal, and a drain connected with the first node.

19. The display apparatus of claim 9, wherein, for each shift register in the gate driving circuit, the output circuit comprises:
a second transistor having a gate connected with the first node, a source connected with the first clock signal terminal, and a drain connected with the output terminal, and
a capacitor having one end connected with the first node, and the other end connected with the output terminal.

20. The driving method of claim 10, wherein the reset control circuit of the shift register comprises:
a first reset control transistor having a gate connected with the reset terminal, a source connected with a first reference potential terminal, and a drain connected with the second node, and
a second reset control transistor having a gate connected with the input terminal, a source connected with the second node, and a drain with a second reference potential terminal.
